(19) United States
(12) Patent Application Publication
(10) Pub. No.: US 2015/0271363 A1
(43) Pub. Date: Sep. 24, 2015

(54) IMAGE PROCESSING APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventors: Shigeru OKADA, Kanagawa (JP); Katsuya KOYANAGI, Kanagawa (JP); Minoru SODEURA, Kanagawa (JP); Shinji HANAOKA, Kanagawa (JP); Shintaro ADACHI, Kanagawa (JP); Hiroyuki KISHIMOTO, Kanagawa (JP)

(21) Appl. No.: 14/558,148

(22) Filed: Dec. 2, 2014

(30) Foreign Application Priority Data
Mar. 19, 2014 (JP) 2014-056985

(51) Int. Cl. H04N 1/40; G06Q 30/04; G06Q 30/02; H04N 1/60

(52) U.S. Cl. CPC H04N 1/40012; H04N 1/6063; H04N 1/6075; G06Q 30/04; G06Q 30/0283; H04N 2201/0094

(57) ABSTRACT

An image processing apparatus includes a color extraction unit that extracts colors of pixels that are included in image information, a classification unit that classifies the pixels into multiple groups that correspond to hues of the pixels on the basis of the colors of the pixels, which have been extracted, a specified group selection unit that selects one or multiple specified groups from the multiple groups, and a color conversion unit that performs color conversion processing in which, colors of multiple pixels that are classified in the specified groups are converted into colors each of which is determined for a corresponding one of the specified groups, and colors of pixels that have been classified in a group other than the specified groups are converted into an achromatic color.

### CROSS-REFERENCE TO RELATED APPLICATIONS

This application is based on and claims priority under 35 USC 119 from Japanese Patent Application No. 2014-056985 filed Mar. 19, 2014.

### BACKGROUND

(i) Technical Field

The present invention relates to an image processing apparatus, an image processing method, and a non-transitory computer readable medium.

(ii) Related Art

In the related art, processing for reducing the number of colors that are included in image data by converting colors of pixels that are included in the image data has been performed. For example, the size of image data may be reduced, and the processing speed may be improved in the case of printing image data or the like by reducing the number of colors.

In a system in which, when image data is printed, a user will be charged in accordance with the number of colors that are included in the image data, a printing fee generally increases in a stepwise manner with the number of colors that are included in the image data. For example, in the case where the number of colors is one, a monochrome printing fee is applied, in the case where the number of colors is two or three, a small-number-of-colors fee is applied, and in the case where the number of colors is four or more, a color fee is applied. In order to reduce a printing fee, the number of colors needs to be reduced to at least two or three in such a manner that the small-number-of-colors fee is applied.

In the case where color-reduction processing is performed on image data, there is a possibility that the appearance of the original image may deteriorate. In particular, in the case of performing processing for reducing the number of colors to two or three, which is an extremely small number, there is a possibility that the appearance of the original image may significantly deteriorate.

### SUMMARY

According to an aspect of the invention, there is provided an image processing apparatus including a color extraction unit that extracts colors of pixels that are included in image information, a classification unit that classifies the pixels into multiple groups that correspond to hues of the pixels on the basis of the colors of the pixels, which have been extracted, a specified group selection unit that selects one or multiple specified groups from the multiple groups, and a color conversion unit that performs color conversion processing in which, colors of multiple pixels that are classified in the specified groups are converted into colors each of which is determined for a corresponding one of the specified groups, and colors of pixels that have been classified in a group other than the specified groups are converted into an achromatic color.

### BRIEF DESCRIPTION OF THE DRAWINGS

Exemplary embodiments of the present invention will be described in detail based on the following figures, wherein:

FIG. 1 is a schematic diagram illustrating configurations of an image processing apparatus according to a first exemplary embodiment and peripheral devices;

FIG. 2 is a diagram illustrating an example of an HSL color space;

FIG. 3 is a conceptual diagram illustrating processing for mapping colors that have been extracted from original image data to the HSL color space;

FIG. 4 is a conceptual diagram illustrating color-conversion processing;

FIG. 5 is a flowchart illustrating the flow of processes in the first exemplary embodiment;

FIG. 6 is a flowchart illustrating an exemplary flow of processes of the color-conversion processing; and

FIG. 7 is a flowchart illustrating the flow of processes in a second exemplary embodiment.

### DETAILED DESCRIPTION

Image processing apparatuses according to first and second exemplary embodiments of the present invention will be described below. Note that the present invention is not limited to the following exemplary embodiments.

### First Exemplary Embodiment

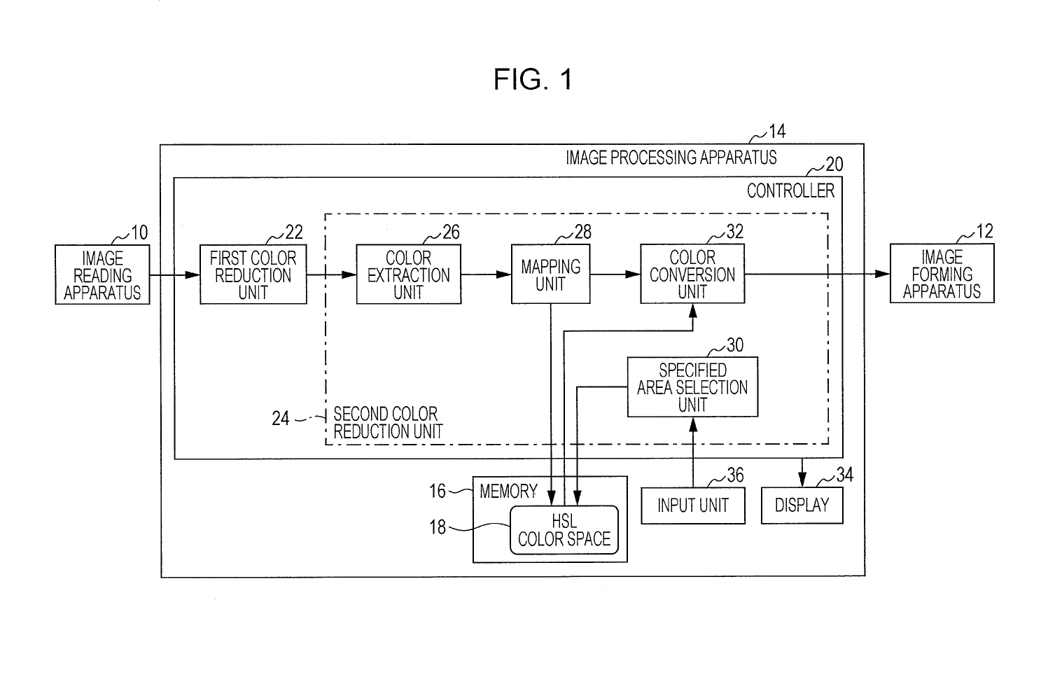

FIG. 1 is a schematic diagram illustrating configurations of an image processing apparatus according to the first exemplary embodiment and peripheral devices. FIG. 1 illustrates an image processing apparatus 14 according to the first exemplary embodiment as well as an image reading apparatus 10 and an image forming apparatus 12 as the peripheral devices.

The image reading apparatus 10 is a color scanner and is configured to optically read a paper document or the like and generate image data that includes plural colors. In the first exemplary embodiment, the image reading apparatus 10 is a scanner that supports 24-bit true color, and image data that is generated by the image reading apparatus 10 may include up to about 16,000,000 colors. The image reading apparatus 10 is not necessarily a scanner that supports 24-bit true color and may be, for example, a scanner that supports 12-bit color (the maximum number of colors is about 4,000) or a scanner that supports 16-bit color (the maximum number of colors is about 65,000).

The image forming apparatus 12 is a color printer and is configured to print image data that has been processed by the image processing apparatus 14 on a paper medium.

The image processing apparatus 14 is a personal computer and includes a memory 16, a controller 20, a display 34, and an input unit 36. The image processing apparatus 14 may be a scanner that has a scanner function of the image reading apparatus 10 or a printer that has a print function of the image forming apparatus 12. Alternatively, the image processing apparatus 14 may be a multifunction machine that has the scanner function of the image reading apparatus 10 and the print function of the image forming apparatus 12.

The memory 16 is a ROM, a RAM, a hard disk drive (HDD), or the like, and programs that are used for realizing each function of the controller 20, results of arithmetic processing that is performed in the image processing apparatus 14, and the like are stored in the memory 16.

An HSL color space 18 is stored in the memory 16. In the HSL color space 18, colors are represented by three components of hue, saturation, and lightness. A different color space, for example, an HSV color space or the like may be used instead of the HSL color space 18. Such a color space that is to be used may be a color space that includes hue, saturation, and lightness as components thereof.

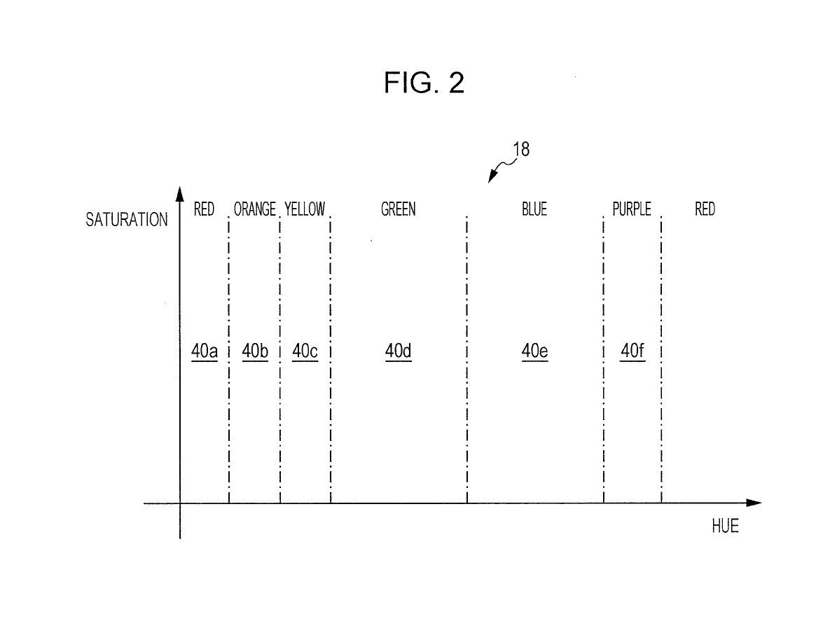

FIG. 2 is a diagram illustrating the HSL color space 18, which is an example of an HSL color space. As described above, the HSL color space 18 includes the three components and normally includes three axes. However, in FIG. 2, illustration of a lightness axis, which is an axis that extends in the vertical direction as viewed in FIG. 2, is omitted. In FIG. 2, the horizontal axis represents hue. Hue continuously changes from red to orange, yellow, green, blue and purple in this order in a direction in which a hue axis extends, and after being changed to purple, the hue returns to red again. In other words, the hue, which is represented by the horizontal axis, periodically changes, and FIG. 2 illustrates one change cycle. In addition, in FIG. 2, the vertical axis represents saturation. As the saturation of a color increases, the color becomes more vivid, and in the case where the saturation is zero, the color is an achromatic color, that is, white, black, or gray, which is a neutral color composed of black and white.

As illustrated in FIG. 2, the HSL color space 18 is divided into plural areas in accordance with hue. In the example illustrated in FIG. 2, the HSL color space 18 is divided into six areas of a red area 40a, an orange area 40b, a yellow area 40c, a green area 40d, a blue area 40e, and a purple area 40f. The number of areas into which the HSL color space 18 is to be divided, the hues in accordance with which the HSL color space 18 is to be divided, and the like may be changed by instructions from a user. For example, the blue area 40e may be divided into a dark blue area and a light blue area, and the orange area 40b and the yellow area 40c may be combined into one area.

Returning to FIG. 1, the controller 20 is a CPU or the like and performs overall control of the image processing apparatus 14. The controller 20 includes a first color reduction unit 22 and a second color reduction unit 24. These units are realized by programs.

The first color reduction unit 22 receives image data from the image reading apparatus 10 and reduces the number of colors that are included in the image data down to a maximum of about 16 colors by using a predetermined method. As the predetermined method, a method that has hitherto been known, such as that described in Japanese Unexamined Patent Application Publication No. 2005-328144 or that described in Japanese Unexamined Patent Application Publication No. 2010-220113, may be used. The first color reduction unit 22 performs color-reduction processing by, for example, extracting a pixel whose hue is close to gray and reducing the saturation of the pixel or performing processing for making the pixel have an achromatic color. Alternatively, the first color reduction unit 22 performs the color-reduction processing by, for example, removing a color in the case where the color difference between the color and another color is small.

The second color reduction unit 24, which will be described later, is configured to classify pixels of image data each of which has a color whose lightness is not lower than a predetermined value into plural groups in accordance with the hues of the colors, which are extracted from the pixels, and perform processing for converting the colors of the pixels on a group-by-group basis. In the case where the second color reduction unit 24 directly performs the color-reduction processing on image data that includes a large number of colors, such as 24-bit true-color image data, the appearance of the image may sometimes be markedly changed. For example, there is a case where a pixel having a color of red that is actually close to black because the lightness of the color is significantly low even though the hue of the color is red is classified into a red group at the time of performing grouping in accordance with hue. In this case, the color that is fundamentally close to black is converted into a color that is close to red by the second color reduction unit 24, and the appearance of the image that has undergone the color-reduction processing performed by the second color reduction unit 24 becomes different from that of the image before undergoing the color-reduction processing. In addition, there is a possibility that processing for converting a color that appears to be green into blue or the like may be performed.

In order to avoid a problem such as that described above, the first color reduction unit 22 performs the color-reduction processing on image data that includes a large number of colors, such as 24-bit true-color image data, in such a manner as to convert the image data into image data that is roughly expressed by about 16 colors. Note that in the case where the image reading apparatus 10 generates image data that is expressed by 16 colors by reading a paper document, the processing that is to be performed by the first color reduction unit 22 may be omitted.

The second color reduction unit 24 includes a color extraction unit 26, a mapping unit 28, a specified area selection unit 30, and a color conversion unit 32. The second color reduction unit 24 receives image data (hereinafter referred to as original image data) that has been color-reduced by the first color reduction unit 22 in such a manner as to be expressed by up to about 16 colors and further reduces the number of colors that are included in the original image data. The number of colors that are to be included in the original image data after the original image data has been color-reduced by the second color reduction unit 24 may be arbitrarily specified by a user. In the first exemplary embodiment, the second color reduction unit 24 may reduce the number of colors that are included in image data down to a maximum of three.

In the first exemplary embodiment, in pixel value representation, colors that are included in achromatic colors (gray scale), which only include information that relates to lightness and do not include information that relates to color, may be considered as the same color. For example, in the case where image data is represented in gray scale, the number of colors that are included in the image data is considered to be one no matter how many variations of white, black, and gray, which is a neutral color composed of black and white, are included in the image data. This is based on the fact that, in a system in which, when an image is printed, a user will be charged in accordance with the number of colors that are included in the image, an image that is represented in gray scale is often considered to have one color. However, as will be described later, colors that have different lightnesses and that are included in an image that is represented in gray scale may be distinguished as different colors.

Each of the units that are included in the second color reduction unit 24 will be described in detail below.

The color extraction unit 26 receives original image data from the first color reduction unit 22 and extracts the colors of pixels of the original image data. The color extraction unit 26 associates information items that indicate the pixels of the original image data (e.g., the coordinates of the pixels) and information items that indicate the colors of the pixels with one another and stores the information items into the memory 16. In the first exemplary embodiment, the information items that indicate the colors, which have been extracted by the color extraction unit 26, are represented in the RGB color model. In other words, the colors are represented by values of components of red (R), green (G), and blue (B).

The mapping unit 28 maps the colors that have been extracted from the pixels of the original image data by the color extraction unit 26 to the HSL color space 18. The colors of the pixels of the original image data, which are represented in the RGB color model, are mapped to the HSL color space 18, so that the colors of the pixels, which have been extracted, are converted from the RGB color model into the HSL color model. Note that, in the first exemplary embodiment, in the case where one of the colors, which have been extracted by the color extraction unit 26, is an achromatic color (i.e., in the case where R, G, and B have the same value), or in the case where the lightness of the color is not higher than the predetermined value, the mapping unit 28 does not perform the mapping processing on the color. This is because there is no need to convert the color of a pixel that already has an achromatic color and because in the case where a color has a lightness not higher than the predetermined value, the color may be determined as an achromatic color. A lightness value that serves as a threshold that is used for determining whether to perform the mapping processing or not may be arbitrarily set by a user.

Processing for converting the colors of pixels that are included in original image data, from the RGB color model to the HSL color model is performed in order to facilitate processing for classifying the pixels, which are included in the original image data, into plural groups in accordance with the hues of the pixels. In the RGB color model, colors are represented by converting three color components of red, green, and blue into numbers, and thus, the RGB color model does not have a parameter that directly represents hue. In contrast, in the HSL color model, colors are represented by three components of hue, saturation, and lightness, and thus, the HSL color model has a parameter that directly represents hue.

For example, a color that has been mapped to the red area 40a of the HSL color space 18 obviously has a hue close to red. Therefore, when a pixel, from which the color that has been mapped to the red area 40a has been extracted, is classified into a group, other pixels each of which has a color whose hue is close to red are classified into the same group. As described above, the colors of the pixels of the original image data are mapped to the HSL color space 18, which has been divided into plural areas in accordance with hue, so that each of the pixels is classified into one of groups that corresponds to the hue of the pixel.

Although, in the first exemplary embodiment, pixels of original image data are classified into plural groups by mapping the colors of the pixels to the HSL color space 18, which has been divided into plural areas in accordance with hue, this classification processing may be performed by using a different method. For example, the colors of the pixels of the original image data may be converted from the RGB color model to a parameter that represents hue, saturation, and lightness by using a color model conversion table (look up table (LUT)) in which colors that are represented in the RGB color model and parameters that indicate the hues, saturations, and lightnesses of the colors are associated with each other. In this state, grouping of some of the pixels each of which has a hue that is not lower than a predetermined value is performed on the basis of a hue parameter. In this case, the color model conversion table is stored instead of the HSL color space 18 in the memory 16.

The specified area selection unit 30 selects one or plural specified areas from the plural areas of the HSL color space 18. When a specified area is selected in the HSL color space 18, a specified group is selected from the plural groups to which the pixels of the original image data have been classified in accordance with the hues of the pixels. For example, in the case where the specified area selection unit 30 selects the red area 40a, which is illustrated in FIG. 2, as a specified area, a red area group that is a group of pixels, from which colors that have been mapped to the red area 40a have been extracted, is selected as a specified group. In the first exemplary embodiment, a user selects a specified area. The specified area selection unit 30 that has received an instruction from the user selects a specified group from the plural groups to which the pixels of the original image data have been classified in accordance with the hues of the pixels.

At a later time, the colors of pixels that belong to the specified group will be integrated into a chromatic color that is determined for the specified group by the color conversion unit 32, and colors that have not undergone the grouping processing because the lightnesses of the colors are lower than the predetermined value and the colors of pixels that belong to groups other than the specified group are converted into an achromatic color. Therefore, a user selects areas in which colors that are desired to be left after the color-reduction processing are included as specified areas. Since the colors of pixels that belong to groups that have been selected as specified areas are integrated on a group-by-group basis, and the colors of pixels that belong to other groups are converted into an achromatic color, a number that is obtained by adding one to the number of the specified groups is the number of colors that are to be included in the original image data after the color-reduction processing has been performed by the second color reduction unit 24.

The specified area selection unit 30 may automatically select specified areas on the basis of the number of times processing for mapping colors to the areas of the HSL color space 18 has been performed. For example, an area to which colors have been mapped the largest number of times by the mapping unit 28 and an area to which colors have been mapped the second largest number of times by the mapping unit 28 may be selected as specified areas. Alternatively, among the areas to which colors have been mapped by the mapping unit 28, an area to which some of the colors have been mapped the smallest number of times and an area to which some of the colors have been mapped the second smallest number of times may be selected as specified areas. It is assumed that a color that appears infrequently in the original image data is particularly noticeable in the original image data, and such a color may sometimes be used for, for example, highlighting and displaying a particular part. A reference for automatically selecting a specified area may be arbitrarily set by a user.

Alternatively, the specified area selection unit 30 may select a specified area on the basis of the number of specified areas that is specified by a user and the priorities of colors that are set by the user. For example, in the case where the user sets the number of specified areas to be two and sets the priorities of red, blue, green, yellow, purple, and orange colors in such a manner that this order is the descending order of the levels of the priorities. In this case, when colors are mapped to the red area 40a, the blue area 40e, and the green area 40d, the red area 40a and the blue area 40e are selected as specified areas. On the other hand, when colors are only mapped to the yellow area 40c, the purple area 40f, and the orange area 40b, the yellow area 40c, and the purple area 40f, are selected as specified areas. As described above, among the areas to which colors are mapped, a predetermined number (the number of specified areas that has been set by the user) of areas that have higher priorities than other areas may be selected as specified areas.

The color conversion unit 32 performs processing for deciding the colors that are to be included in the pixels, which are included in the original image data, after the color-reduction processing has been performed. First, the color conversion unit 32 converts the colors of plural pixels that belong to a specified group that has been selected by the specified area selection unit 30 into a single color that is determined for the specified group. For example, in the case where colors of vivid red, dark red, red close to pink, and the like have been mapped to the red area 40a, and the red group is selected as a specified group, in the original image data, the colors of the pixels, which are vivid red, dark red, and red close to pink, are converted into a single red color.

Various algorithms may be used for deciding the color into which the colors of the pixels that belong to the specified group are to be converted. It is desirable that a user be capable of selecting an algorithm to be used.

For example, a simple averaging method in which the RGB values of the colors of pixels that belong to a specified group are referred to in such a manner as to calculate an average value of each of the R, G, and B values, and a color that is represented by the average values of the R, G, and B values, which have been calculated, is set as the color of each of the pixels after being converted may be used.

Alternatively, a weighted average method in which, in the case where pixels that have the same color are present in original image data, the color is weighted in accordance with the number of the pixels that have the color, and in addition, a weighted average value of each of the R, G, and B values of the colors of pixels that belong to a specified group is calculated, and a color that is represented by the weighted average values of the R, G, and B values, which have been calculated, is set as the color of each of the pixels after being converted may be used.

Alternatively, an on-pixel determining method in which, among the colors of pixels that belong to a specified group, the color that is included in the largest number of the pixels in original image data is set as the color of each of the pixels after being converted may be used. In the case where there are regions in each of which pixels having the same color are continuously arranged in such a manner as to be adjacent to one another in the original image data, among the colors of the pixels that belong to the specified group, a color that is used in the region that has the largest area may be set as the color of each of the pixels after being converted.

Since a specified area is an area in which a color that is desired to be left in original image data by a user is included, a color that has been mapped to the specified area, that is, the color of a pixel that belongs to a specified group may be left as is. On the other hand, the color-reduction processing may be performed on the colors of pixels that belong to the specified group as much as possible. Therefore, the color conversion unit 32 integrates the colors of the pixels that belong to the specified group into a single color having a hue close to the hues of the colors of the pixels, which belong to the specified group, that is, leaves the colors of the pixels that are desired to be left by a user by integrating the colors of the pixels into a single color having a hue close to the hues of the colors of the pixels, so that the color-reduction processing is performed while the appearance of the original image is maintained as much as possible.

Next, the color conversion unit 32 performs processing for converting the colors of pixels that belong to a group that is not a specified group (hereinafter referred to as non-specified group) into an achromatic color. Pixels that have not undergone the mapping processing because the lightnesses of the colors of the pixels are not higher than a predetermined value are also included in the non-specified group. More specifically, the color conversion unit 32 performs processing for setting the saturations of the colors of the pixels that belong to the non-specified group at zero. In the HSL color space 18, an area that has not been selected as a specified area by the specified area selection unit 30 (hereinafter referred to as non-specified area) is an area in which a color that has been determined to have a relatively low priority in the original image data is included. Thus, it is assumed that even if the colors of the pixels that belong to the non-specified group, which is a group of pixels whose colors have been mapped to the non-specified area, are converted into an achromatic color, the appearance of the original image data will only be changed to a small extent. Accordingly, the color conversion unit 32 integrates the colors of all the pixels, which belong to the non-specified group, into one color by converting the colors into an achromatic color. This causes the number of colors that are included in the original image data to be further reduced while reducing the degree of the change in the appearance of the original image data.

An achromatic color that is the color of a pixel after being converted may have a lightness value. The color conversion unit 32 may determine the lightness of the achromatic color, which is to be the color of the pixel after being converted, on the basis of the color of the pixel before being converted. For example, the color of a pixel that belongs to a non-specified group is converted from a color in the RGB color model into a color in the YUV color model, and a luminance value (Y) in the YUV color model is substituted for each of R, G, and B in the RGB color model. Through this processing, an achromatic color is obtained, and the achromatic color has a lightness based on the color of the pixel before being converted. This further reduces the degree of the change in the appearance of an image due to the color-reduction processing.

Alternatively, the color conversion unit 32 may convert the colors of all the pixels that belong to the non-specified group into an achromatic color that has a predetermined lightness. For example, in a system in which colors are determined as different colors due to the difference in lightness even if all the colors are achromatic colors, the above-described processing is effective in the case where it is desired to reduce the number of colors to a predetermined number or lower and the like.

Alternatively, the color conversion unit 32 may perform processing for converting a color whose saturation is not higher than a predetermined value among the colors of pixels that are included in original image data into an achromatic color, that is, converting the saturation of the color into zero regardless of the hue of the color. Such a color having a low saturation is close to gray, and thus, it is assumed that the appearance of an original image will not be markedly changed even if the color is converted into an achromatic color. Therefore, the color conversion unit 32 further reduces the number of colors that are included in the original image while reducing the degree of the change in the appearance of the original image by converting the color whose saturation is not higher than the predetermined value into an achromatic color. Note that a saturation threshold that serves as a threshold that is used for determining whether to convert a color into an achromatic color or not may be arbitrarily set by a user.

As illustrated in FIG. 2, in the HSL color space 18, the vertical axis represents saturation. Thus, it may be easily determined whether or not the saturation of the color of a pixel that is included in an original image is lower than or equal to a predetermined value on the basis of the saturation parameter of the HSL color model.

Returning to FIG. 1, the display 34 is a monitor and is configured to display an image and the like in order to help a user instruct the image processing apparatus 14. For example, in order to allow the user to select the number of areas into which the HSL color space 18 is to be divided, hues in accordance with which the HSL color space 18 is to be divided, and the like, the display 34 displays plural patterns for dividing the HSL color space 18. Alternatively, in order to allow the user to select a specified area, the display 34 may display the HSL color space 18 that has been divided. In addition to the above, the display 34 may display the contents of processing that is performed by the image processing apparatus 14 and the like.

An input unit 38 is a mouse, a keyboard, an operation panel, or the like and is used for inputting an instruction from a user to the image processing apparatus 14.

The schematic configurations of the image processing apparatus 14 according to the first exemplary embodiment and the peripheral devices have been described above. The specific contents of processing that is performed by the second color reduction unit 24 will be described below.

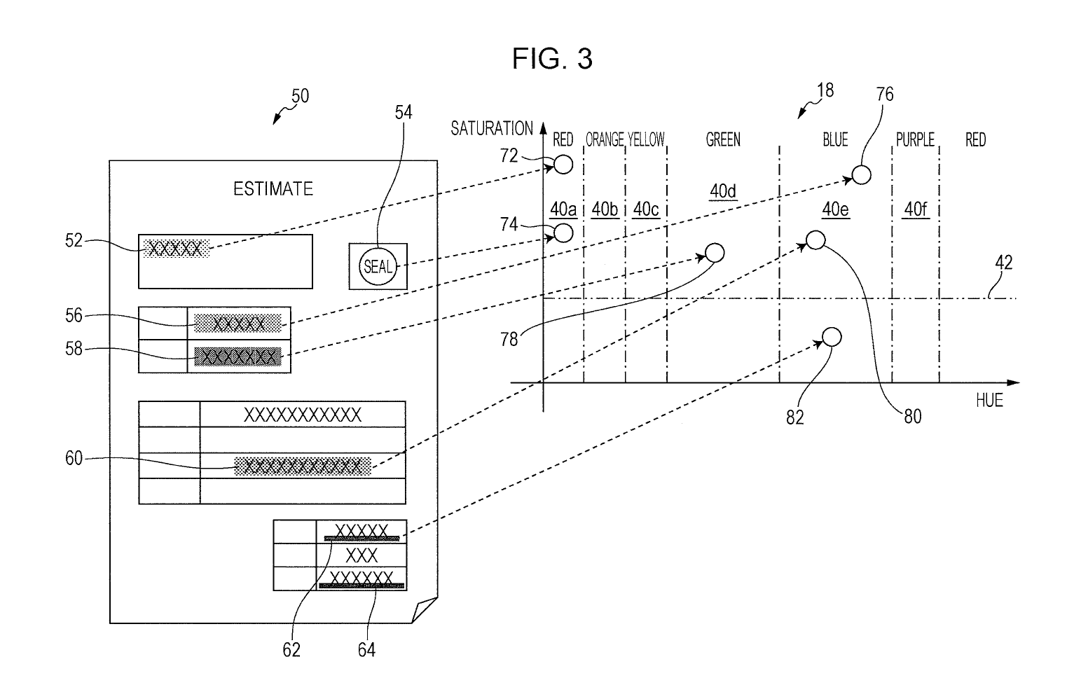

FIG. 3 is a conceptual diagram illustrating processing for mapping colors that have been extracted from original image data to the HSL color space 18. The processing illustrated in FIG. 3 will be described with reference to FIG. 1. Original image data 50 includes colors of white, which is the color of a sheet, black and gray scale (these colors are considered as one color as described above), which are the colors of characters, tables and the like, and in addition, includes seven variations of red of a red marking 52, somewhat dark red of a seal impression 54, blue of a blue marking 56, green of a green marking 58, light blue of a light blue marking 60, blue which is close to gray of a blue line 62, and a color having a lightness lower than a predetermined value of a marking 64. The colors of pixels of the original image data 50 are extracted by the color extraction unit 26.

The mapping unit 28 maps only colors each having a lightness not lower than a predetermined value among the colors of the pixels of the original image data 50, which have been extracted by the color extraction unit 26, to the HSL color space 18. As described above, the HSL color space 18 has been divided into the six areas, which are the red area 40a, the orange area 40b, the yellow area 40c, the green area 40d, the blue area 40e, and the purple area 40f. A saturation threshold 42 that has been set by a user is represented by a two-dot chain line.

As illustrated in FIG. 3, the color of the red marking 52 and the color of the seal impression 54 are respectively mapped to coordinates 72 and coordinates 74 in the red area 40a. As a result, a pixel that has the color of the red marking 52 and a pixel that has the color of the seal impression 54 are classified into the same group (the red group). Similarly, the color of the blue marking 56, the color of the light blue marking 60, and the color of the blue line 62 are respectively mapped to coordinates 76, coordinates 80, and coordinates 82 in the blue area 40e. As a result, pixels that have these colors are classified into a blue group. In addition, the color of the green marking 58 is mapped to the coordinates 78 in the green group 40d, and a pixel that has the color of the green marking 58 is classified into a green group. The color of the marking 64, which has the lightness lower than the predetermined value, will not be mapped due to the lightness thereof, which is lower than the predetermined value. Note that the original image data 50 does not include colors that are to be classified into the orange area 40b, the yellow area 40c, and the purple area 40f, and thus, no color will be mapped to these areas.

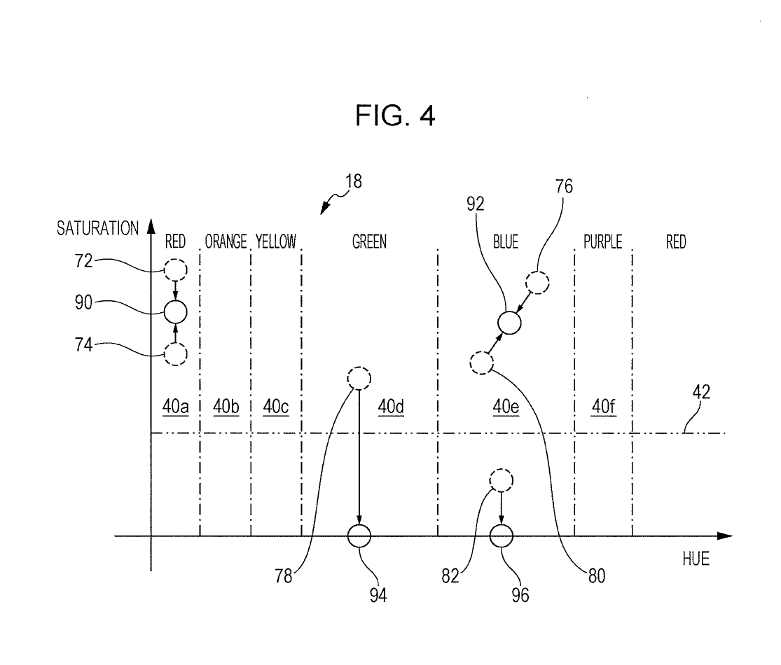

FIG. 4 is a conceptual diagram illustrating color-conversion processing. The processing illustrated in FIG. 4 will be described with reference to FIG. 1. In the example illustrated in FIG. 4, the red area 40a and the blue area 40e are selected as specified areas, that is, the red group and the blue group are selected as specified groups. The color conversion unit 32 converts the colors of pixels that belong to the red group, which is the specified group, into a single color. In the example illustrated in FIG. 4, a color that is represented by coordinates 90, which is a midpoint between, in the red area 40a, the coordinates 72 and the coordinates 74 to which the color of the red marking 52 and the color of the seal impression 54 have been mapped, respectively, is the color of the pixels after being converted. The color conversion unit 32 converts the colors of all the pixels that belong to the red group into the color that is represented by the coordinates 90.

The color conversion unit 32 converts the colors of pixels that belong to the green group, which is a non-specified group, into an achromatic color. As illustrated in FIG. 4, the color of the pixel, which belongs to the green group and which is represented by the coordinates 78, is converted into a color that is represented by coordinates 94 and that has a saturation of zero. As described above, the achromatic color, which is the color of the pixel, which is represented by the coordinates 78 and which has been converted, may have a lightness value based on the color of the pixel.

The color conversion unit 32 converts the color of the pixels that belong to the blue group, which is the specified group, into a single color. The color (the color of the blue marking 56) that is represented by the coordinates 76 and that has a saturation not lower than the saturation value 42, the color (the color of the light blue marking 60) that is represented by the coordinates 80 and that has a saturation not lower than the saturation value 42, and the color (the color of the blue line 62) that is represented by the coordinates 82 and that has a saturation lower than the saturation value 42 are included in the blue area 40e.

First, the color conversion unit 32 converts the colors each of which has a saturation not lower than the saturation value 42 and each of which is extracted from some of the pixels that belong to the blue group into a single color. In the example illustrated in FIG. 4, the color represented by the coordinates 92, which is a midpoint between the coordinates 76 and the coordinates 80 of the colors that have been mapped to a region above the saturation value 42 in the blue area 40e, is the color of each of the pixels after being converted. The color conversion unit 32 converts the colors each of which has a saturation not lower than the saturation value 42 and each of which is extracted from some of the pixels, which belong to the blue group, into the color, which is represented by the coordinates 92.

Next, the color conversion unit 32 converts the colors each of which has a saturation lower than the saturation value 42 and each of which is extracted from some of the pixels, which belong to the blue group, into an achromatic color. As illustrated in FIG. 4, the color that has a saturation lower than the saturation value 42 and that is extracted from the pixel that is represented by the coordinates 82 and that belongs to the blue group into a color that has a saturation of zero and that is represented by coordinates 96. As described above, the achromatic color that is the color of the pixel, which is represented by the coordinates 82 and which has been converted, may have a lightness based on the color of the pixel.

In addition, as in the case of converting the pixels that belong to the non-specified group, the color conversion unit 32 converts the color of a pixel that has not been mapped due to the lightness of the color, which is lower than a predetermined value, into an achromatic color.

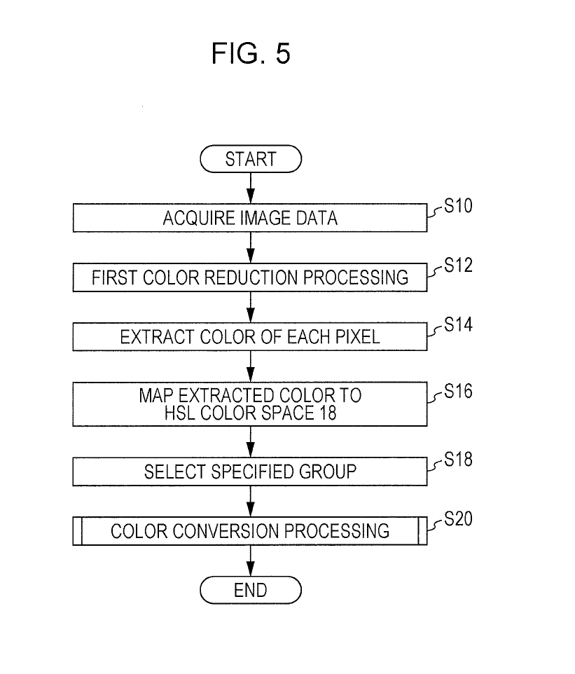

The flow of processes that are to be performed by the image processing apparatus 14 according to the first exemplary embodiment will be described below. FIG. 5 is a flowchart illustrating the flow of the processes in the first exemplary embodiment. The flowchart illustrated in FIG. 5 will be described with reference to FIG. 1.

In step S10, the image processing apparatus 14 acquires 24-bit true color image data that is generated by the image reading apparatus 10. The image processing apparatus 14 may acquire the image data by wired communication using a USB cable or the like or by wireless communication using Wi-Fi or the like. Alternatively, the image data may be transmitted from the image reading apparatus 10 to the image processing apparatus 14 by using a USB memory or the like.

In step S12, the first color reduction unit 22 converts the 24-bit true color image data, which has been acquired in step S10, into image data (original image data) that is expressed by 16 colors. As described above, a method of the related art is used for the conversion processing that is performed by the first color reduction unit 22.

The processes of step S14 to step S18 are second color reduction processing that is to be performed by the second color reduction unit 24. In step S14, the color extraction unit 26 extracts the colors of pixels of the original image data. The colors, which have been extracted, are represented in the RGB color model.

In step S16, the mapping unit 28 maps only colors each having a lightness not lower than a predetermined value among the colors of the pixels of the original image data, which have been extracted in step S14, to the HSL color space 18. By being mapped to the HSL color space 18, the colors of the pixels of the original image data are converted into colors that are represented in the HSL color model. Since the HSL color space 18 has been divided into plural areas in accordance with hue, the pixels of the original image data are classified into plural groups in accordance with the hues of the pixels by performing the mapping processing.

In step S18, the specified area selection unit 30 selects a specified group from the plural groups, in which the pixels have been classified in step S16. As described above, the specified group is selected by selecting a specified area from the plural areas of the HSL color space 18.

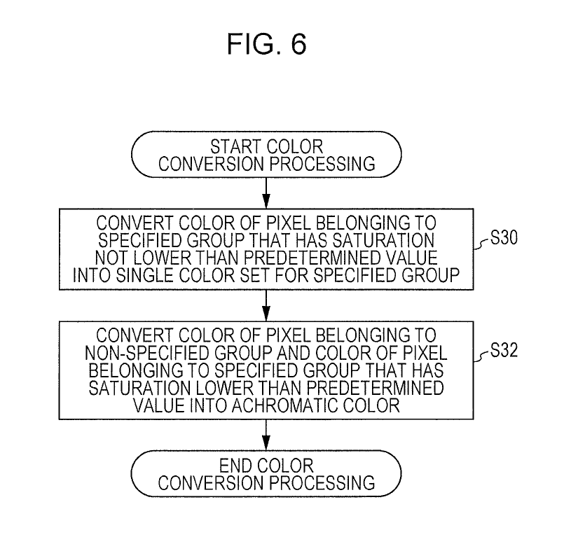

In step S20, the color conversion unit 32 performs processing for converting the colors of the pixels of the original image data. The process of step S20 will be described with reference to FIG. 6. FIG. 6 is a flowchart illustrating an exemplary flow of processes of the color-conversion processing.

In step S30, the color conversion unit 32 refers to the saturations of the colors of the pixels that belong to the specified group and converts the colors each having a saturation not lower than a predetermined value into a single color that is determined for the specified area. Since the colors of the pixels of the original image data have been converted to the colors that are represented in the HSL color model, which has saturation as a parameter thereof, it may be easily determined whether or not the saturations of the colors of the pixels are equal to or higher than the predetermined value by referring to a saturation parameter.

In step S32, first, the color conversion unit 32 converts the colors of the pixels (including the pixels that have not been mapped due to the lightnesses of the pixels that are lower than the predetermined value) that belong to the non-specified group into an achromatic color. Then, the color conversion unit 32 refers to the saturations of the colors of the pixels that belong to the specified group and converts the colors each having a saturation lower than the predetermined value into an achromatic color.

### Second Exemplary Embodiment

Among image data items that are to be printed, there are image data items that need to be printed in various colors. An example of such an image data item includes a line graph that includes a large number of graph lines, which are identified by the colors of the graph lines. In such a case, it is very likely that a user intends to print the image data item, which includes a large number of colors, as is without performing color reduction processing even if the user will be charged an expensive fee. In this case, if the user needs to specify whether to perform the color reduction processing or not by using an operation panel or the like, the user will be forced to perform a troublesome operation. In the second exemplary embodiment, is automatically determined whether to perform the color reduction processing or not in accordance with the number of colors that are included in original image.

The configuration of the image processing apparatus according to the second exemplary embodiment and the contents of color reduction processing according to the second exemplary embodiment are the same as those of the first exemplary embodiment, and thus, description thereof will be omitted. In the second exemplary embodiment, a difference from the first exemplary embodiment is that, before the color conversion unit 32 performs color conversion processing, it is determined whether to perform the color conversion processing or not.

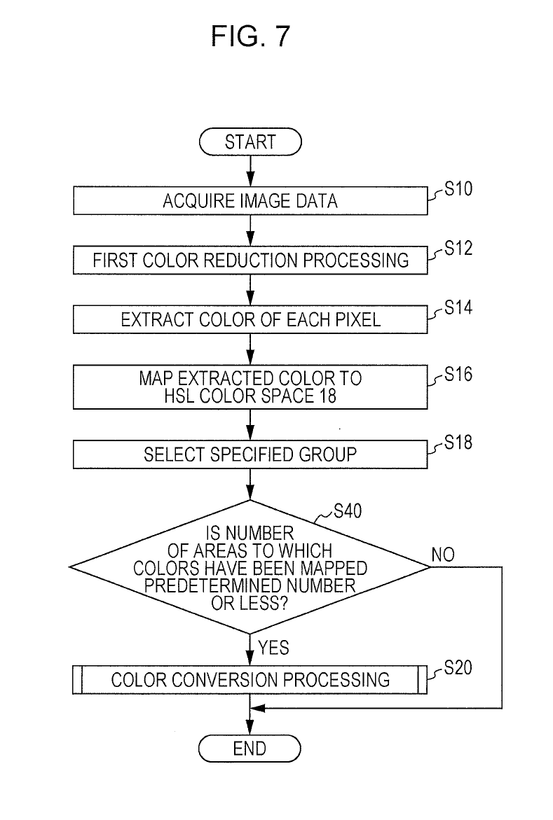

FIG. 7 is a flowchart illustrating the flow of processes in the second exemplary embodiment. The processes of step S10 to step S16 and the contents of the process of step S18 are similar to those of the first exemplary embodiment, and thus, description thereof will be omitted.

In step S40, the color conversion unit 32 determines whether or not the number of areas to which colors have been mapped in the HSL color space 18 is lower than or equal to a predetermined number. In the example illustrated in FIG. 3, the areas to which the colors, which have been extracted from the original image data 50, have been mapped are the red area 40a, the green area 40d, and the blue area 40e, and thus, the number of areas to which colors have been mapped is three.

Only in the case where it has been determined that the number of areas to which colors have been mapped is lower than or equal to the predetermined number in step S40, the color conversion unit 32 performs the color conversion processing in step S20. In the case where the number of areas to which colors have been mapped is higher than the predetermined number, the original image data is output as is without undergoing the color conversion processing (i.e., the second color reduction unit 24 does not perform color-reduction).

In the HSL color space 18, which has been divided into the plural areas in accordance with hue, as the number of areas to which colors have been mapped increases, the original image data 50 is more likely to be determined to include various colors (i.e., to have a wide-ranging hue). For example, in the example illustrated in FIG. 3, in the case where the original image data 50 further includes colors of orange and purple, these colors are extracted and mapped to the orange area 40b and the purple area 40f, respectively. As a result, the number of areas to which colors have been mapped further increases. Contrary to this, as the number of areas to which colors have been mapped decreases, the original image data 50 is more likely to be determined to include a small number of colors or only include colors that are similar to one another.

Therefore, in step S40, it is determined whether or not the original image data 50 includes various colors by detecting the number of areas to which colors have been mapped. In the case where the original image data 50 includes various colors, it is determined that the color reduction processing is not desired by the user, and the original image data 50 is output as is without undergoing the color reduction processing. On the other hand, in the case where the original image data 50 does not include various colors, it is determined that the appearance of the original image data 50 will not significantly deteriorate even if the color reduction processing is performed, and the color reduction processing is performed in such a manner that the original image data 50 that has been color-reduced is output.

In the case where the color reduction processing is to be performed when the number of areas to which colors have been mapped is not higher than a particular number, the user may arbitrarily set the particular number. The particular number may be decided in accordance with the setting of a billing system.

According to the second exemplary embodiment, it is automatically determined whether to perform the color reduction processing or not in accordance with variations of colors that are included in original image data.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a color extraction unit that extracts colors of pixels that are included in image information;
a classification unit that classifies the pixels into a plurality of groups that correspond to hues of the pixels on the basis of the colors of the pixels, which have been extracted;
a specified group selection unit that selects one or a plurality of specified groups from the plurality of groups; and
a color conversion unit that performs color conversion processing in which, colors of a plurality of pixels that are classified in the specified groups are converted into colors each of which is determined for a corresponding one of the specified groups, and colors of pixels that have been classified in a group other than the specified groups are converted into an achromatic color.

2. The image processing apparatus according to claim 1,
wherein the classification unit classifies pixels that have colors whose lightness is not lower than a predetermined value among the colors of the pixels that have been extracted by the color extraction unit into the plurality of groups, which correspond to the hues of the pixels, and
wherein the color conversion unit converts the colors of the plurality of pixels that are classified in the specified groups into the colors, which are determined for the corresponding specified groups, and converts the colors of the pixels that have been classified in the group other than the specified groups or a color that has not been classified in any of the groups due to a lightness of the color that is lower than the predetermined value into an achromatic color.

3. The image processing apparatus according to claim 1,
wherein, among the colors of the pixels that have been classified in the specified groups, the color conversion unit converts the colors of the pixels each of which has a saturation not lower than a predetermined value into the colors, which are determined for the corresponding specified groups, and converts the colors of the pixels each of which has a saturation lower than the predetermined value into an achromatic color.

4. The image processing apparatus according to claim 2,
wherein, among the colors of the pixels that have been classified in the specified groups, the color conversion unit converts the colors of the pixels each of which has a saturation not lower than a predetermined value into the colors, which are determined for the corresponding specified groups, and converts the colors of the pixels each of which has a saturation lower than the predetermined value into an achromatic color.

5. The image processing apparatus according to claim 1,
wherein the color conversion unit determines lightnesses of the pixels whose colors have been converted to the achromatic color through the color conversion processing in accordance with the colors of the pixels before the color conversion processing is performed on the pixels.

6. The image processing apparatus according to claim 2,
wherein the color conversion unit determines lightnesses of the pixels whose colors have been converted to the achromatic color through the color conversion processing in accordance with the colors of the pixels before the color conversion processing is performed on the pixels.

7. The image processing apparatus according to claim 3,
wherein the color conversion unit determines lightnesses of the pixels whose colors have been converted to the achromatic color through the color conversion processing in accordance with the colors of the pixels before the color conversion processing is performed on the pixels.

8. The image processing apparatus according to claim 4,
wherein the color conversion unit determines lightnesses of the pixels whose colors have been converted to the achromatic color through the color conversion processing in accordance with the colors of the pixels before the color conversion processing is performed on the pixels.

9. The image processing apparatus according to claim 1,
wherein the color conversion unit performs the color conversion processing when there are lower than or equal to a predetermined number of groups in which the pixels have been classified by the classification unit.

10. The image processing apparatus according to claim 2,
wherein the color conversion unit performs the color conversion processing when there are lower than or equal to a predetermined number of groups in which the pixels have been classified by the classification unit.

11. The image processing apparatus according to claim 3,
wherein the color conversion unit performs the color conversion processing when there are lower than or equal to a predetermined number of groups in which the pixels have been classified by the classification unit.

12. The image processing apparatus according to claim 4,
wherein the color conversion unit performs the color conversion processing when there are lower than or equal to a predetermined number of groups in which the pixels have been classified by the classification unit.

13. The image processing apparatus according to claim 5,
wherein the color conversion unit performs the color conversion processing when there are lower than or equal to a predetermined number of groups in which the pixels have been classified by the classification unit.

14. The image processing apparatus according to claim 6,
wherein the color conversion unit performs the color conversion processing when there are lower than or equal to a predetermined number of groups in which the pixels have been classified by the classification unit.

15. The image processing apparatus according to claim 7,
wherein the color conversion unit performs the color conversion processing when there are lower than or equal to a predetermined number of groups in which the pixels have been classified by the classification unit.

16. The image processing apparatus according to claim 8,
wherein the color conversion unit performs the color conversion processing when there are lower than or equal to a predetermined number of groups in which the pixels have been classified by the classification unit.

17. An image processing method comprising:
extracting colors of pixels that are included in image information;
classifying the pixels into a plurality of groups that correspond to hues of the pixels on the basis of the colors of the pixels, which have been extracted;
selecting one or a plurality of specified groups from the plurality of groups; and
performing color conversion processing in which, colors of a plurality of pixels that are classified in the specified groups are converted into colors each of which is determined for a corresponding one of the specified groups, and colors of pixels that have been classified in a group other than the specified groups are converted into an achromatic color.

18. A non-transitory computer readable medium storing a program causing a computer to perform a process, the process comprising:
extracting colors of pixels that are included in image information;
classifying the pixels into a plurality of groups that correspond to hues of the pixels on the basis of the colors of the pixels, which have been extracted;
selecting one or a plurality of specified groups from the plurality of groups; and
performing color conversion processing in which, colors of a plurality of pixels that are classified in the specified groups are converted into colors each of which is determined for a corresponding one of the specified groups, and colors of pixels that have been classified in a group other than the specified groups are converted into an achromatic color.
